(19) United States
(12) Patent Application Publication
(10) Pub. No.: US 2015/0062371 A1
(43) Pub. Date: Mar. 5, 2015

(54) ENCODING APPARATUS AND METHOD

(71) Applicant: CANON KABUSHIKI KAISHA, Tokyo (JP)

(72) Inventor: Koji Togita, Yokohama-shi (JP)

(21) Appl. No.: 14/473,332

(22) Filed: Aug. 29, 2014

(30) Foreign Application Priority Data
Sep. 2, 2013 (JP) 2013-181562

(51) Int. Cl. H04N 19/119; H04N 19/176; H04N 19/593; H04N 19/136

(52) U.S. Cl. CPC H04N 19/00072; H04N 19/00139; H04N 19/00278; H04N 19/00763
USPC 348/222.1

(57) ABSTRACT

An encoding apparatus includes an image capture unit configured to capture an image through a lens; a characteristic determination unit configured to determine characteristics of the image based on a difference between a predetermined region where characteristics of the lens influence image quality and another region; a size determination unit configured to determine, based on the characteristics of the image, a block size used to divide a target block included in the image; a division unit configured to divide the target block into a plurality of blocks based on the determined block size; and a prediction coding unit configured to encode the plurality of blocks.

### BACKGROUND

1. Field of the Invention

The present invention relates to an encoding apparatus and an encoding method.

2. Description of the Related Art

There are conventionally known an image capture apparatus, a mobile communication apparatus, and the like as encoding apparatuses for performing compression/prediction coding of moving image data. The image capture apparatus or the mobile communication apparatus acquires a moving image signal based on an image captured by an image capture unit, performs compression coding of the acquired moving image signal, and records the thus obtained signal in a storage medium.

As a technique of performing compression coding of a moving image signal, there is conventionally proposed a technique of performing compression coding of a moving image signal into a format such as MPEG, MPEG2, or H.264/AVC. Such compression coding technique is used for, for example, a recording apparatus for recording a television broadcast program. Japanese Patent Laid-Open No. 2010-288080 discloses a technique of changing a threshold for determining the size of a DCT block in accordance with genre information of a broadcast program.

If, however, the same process is applied within one screen as described in Japanese Patent Laid-Open No. 2010-288080, when coding images having different image qualities within the one screen, the coding efficiency may decrease.

### SUMMARY

According to an aspect of the present invention, there is provided an improved technique or new technique of coding an image.

According to an aspect of the present invention, there is provided an encoding apparatus comprising: an image capture unit configured to capture an image through a lens; a characteristic determination unit configured to determine characteristics of the image based on a difference between a predetermined region where characteristics of the lens influence image quality and another region; a size determination unit configured to determine, based on the characteristics of the image, a block size used to divide a target block included in the image; a division unit configured to divide the target block into a plurality of blocks based on the determined block size; and a prediction coding unit configured to encode the plurality of blocks.

Further features and aspects of the present invention will become apparent from the following description of exemplary embodiments.

### BRIEF DESCRIPTION OF THE DRAWINGS

FIG. 1 is a block diagram showing an example of an arrangement of an encoding apparatus according to a first exemplary embodiment;

FIG. 2 is a table showing an example of a table indicating characteristics of an input image based on a type of lens according to the first exemplary embodiment and a second exemplary embodiment;

FIG. 3A to FIG. 3C2 are views for explaining an example of lens characteristics in a region of an image according to the first exemplary embodiment and the second exemplary embodiment;

FIG. 4 is a view for explaining an example of an input image division method according to the first exemplary embodiment and the second exemplary embodiment;

FIG. 5 is a flowchart illustrating an example of a block division process according to the first exemplary embodiment;

FIG. 6 is a block diagram showing an example of an arrangement of an encoding apparatus according to the second exemplary embodiment; and

FIG. 7 is a flowchart illustrating an example of a block changing process according to the second exemplary embodiment.

### DESCRIPTION OF THE EMBODIMENTS

Exemplary embodiments, features, and aspects of the present invention will be described in below with reference to the drawings.

Note that each functional block described in the following exemplary embodiments need not always be an individual hardware component. That is, for example, the functions of some functional blocks may be executed by one hardware component. Alternatively, several hardware components may cooperate with each other to execute the function or functions of one or a plurality of functional blocks. The function of each functional block may be executed by a program loaded into a memory by a CPU (Central Processing Unit).

### First Exemplary Embodiment

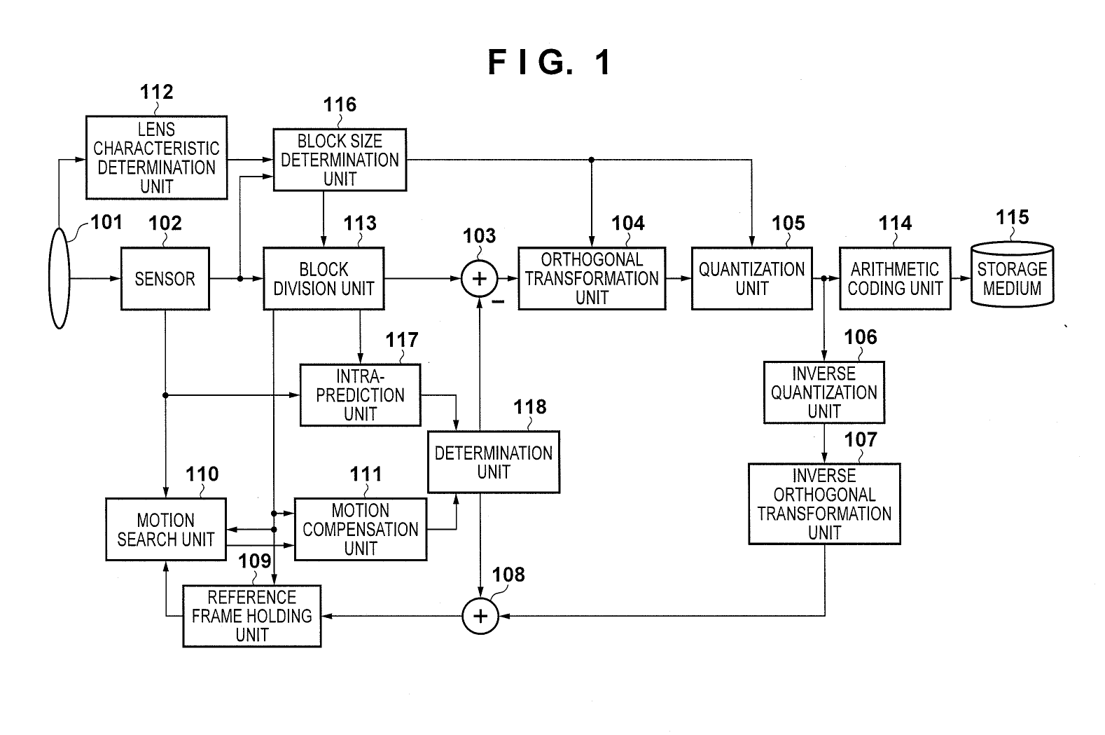

FIG. 1 is a block diagram showing an example of an arrangement of an encoding apparatus according to the first exemplary embodiment. The encoding apparatus generates a coded stream by dividing an input image into blocks having a variable size, and performing prediction coding, and records the generated coded stream. Note that the encoding apparatus according to the first exemplary embodiment is capable of acting as at least one of a mobile phone, PDA (Personal Digital Assistant), smart phone, and tablet PC each having a camera function, or at least one of a digital camera and digital video camera. Respective blocks of the encoding apparatus shown in FIG. 1 except for physical devices such as a lens and image sensor may be implemented with hardware using dedicated logic circuits and memories. Alternatively, the respective blocks may be implemented with software by causing a computer such as a CPU (Central Processing Unit) to execute processing programs stored in a memory to control the operation of the apparatus.

In the first exemplary embodiment, a camera apparatus including a lens and image sensor will be exemplified as an encoding apparatus. However, any apparatus which includes a prediction coding unit and determines a block size to be used in the process by the prediction coding unit according to lens information pertaining to a coding target image may be used.

<Coding Process>

The arrangement of an encoding apparatus and a coding process executed by the apparatus according to the first exemplary embodiment will be described. A lens 101 captures, from the outside, light reflected by an object, and outputs the light to a sensor 102 while outputting the information of the lens to a lens characteristic determination unit 112. The lens characteristic determination unit 112 determines the characteristics of an input image based on the type of the attached lens 101. More specifically, the lens characteristic determination unit 112 notifies a block size determination unit 116 of a region, of the input image, where the lens characteristics appear. The block size determination unit 116 determines a block size for coding process for each region based on the characteristics of each region sent by the lens characteristic determination unit 112 and the features of each region of image data supplied by the sensor 102. The lens characteristics and the block size will be described in detail later.

The sensor 102 includes an image sensor such as a CMOS or CCD, and converts an object image obtained by receiving light through the lens 101 into an image, and outputs the image to a block division unit 113, the block size determination unit 116, a motion search unit 110, and an intra-prediction unit. 117. The block division unit 113 divides the input image into first coding blocks having the same size, and then divides the first coding block into second coding blocks according to an instruction of the block size determination unit 116.

The motion search unit 110 performs pattern matching using a coding target prediction block and a reference frame image held by a reference frame holding unit 109 (to be described later). Based on a combination whose error in pattern matching is smallest, the motion search unit 110 detects the motion vector of the prediction block in the input image. The motion vector of the prediction block calculated by the motion search unit 110 is output to a motion compensation unit 111. The motion compensation unit 111 performs a prediction process for the prediction block based on the reference frame image and the motion vector, thereby generating a predicted image. The predicted image is output to a determination unit 118. In the above motion search process, the size of the prediction block is determined. The intra-prediction unit 117 selects one of a plurality of intra-prediction modes, whose coding efficiency is high, using pixels around the prediction block to be coded as a reference image, thereby generating a predicted image.

The determination unit 118 selects and determines a coding prediction method based on the output results of the intra-prediction unit 117 and the motion compensation unit 111. For example, the determination unit 118 can derive the inter-screen difference value between the coding target image and the predicted image calculated by the intra-prediction unit 117 for the coding target block and that between the coding target image and the predicted image generated by the motion compensation unit 111, compare the difference values with each other, and select the method which yields a smaller difference. Upon determining the prediction method, the determination unit 118 outputs the predicted image generated by the selected method to a subtractor 103 and an adder 108.

The subtractor 103 calculates a prediction error between the pixel value of the prediction block of the input image and that of the predicted image, and outputs the prediction error to an orthogonal transformation unit 104. The orthogonal transformation unit 104 transforms the prediction error into, for example, a discrete cosine coefficient for each quantization block determined by the block size determination unit 116. A quantization unit 105 quantizes the discrete cosine coefficient input from the orthogonal transformation unit 104 for each quantization block determined by the block size determination unit 116.

An inverse quantization unit 106 and an inverse orthogonal transformation unit 107 respectively perform inverse quantization and inverse orthogonal transformation for the quantization result of the quantization unit 105, thereby obtaining a decoded prediction error. The adder 108 adds the decoded prediction error to the predicted image to obtain a locally decoded image as a result of local decoding. The reference frame holding unit 109 holds, as a reference frame image, the locally decoded image obtained by the adder 108. An arithmetic coding unit 114 performs entropy coding for the quantization result and the motion vector obtained by the motion compensation unit 111 for each second coding block, and outputs the result to a storage medium 115 as a stream.

<Lens Characteristic Notification Process>

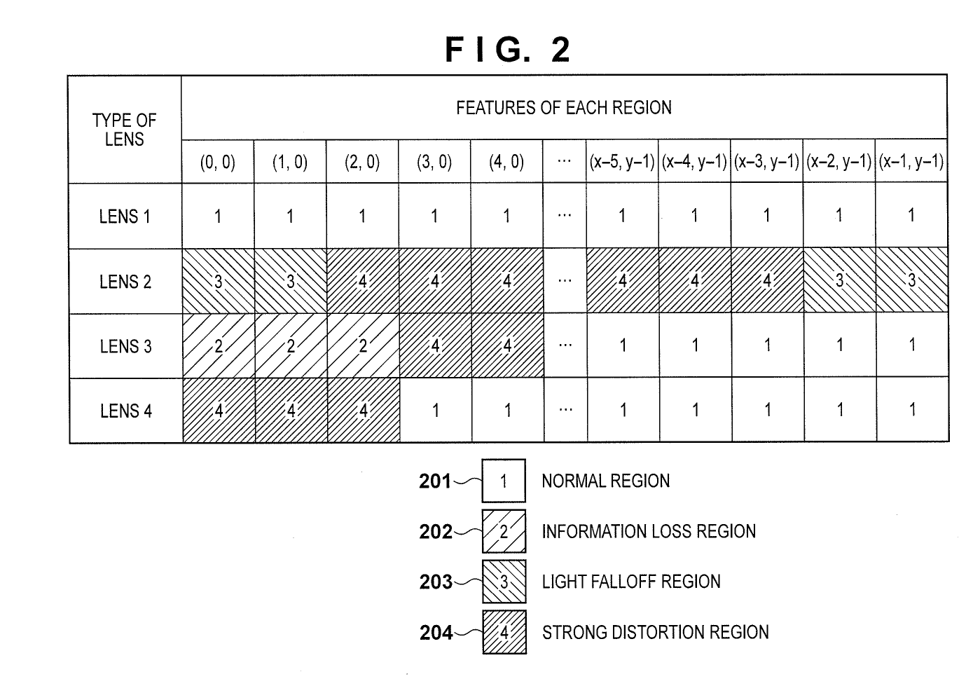

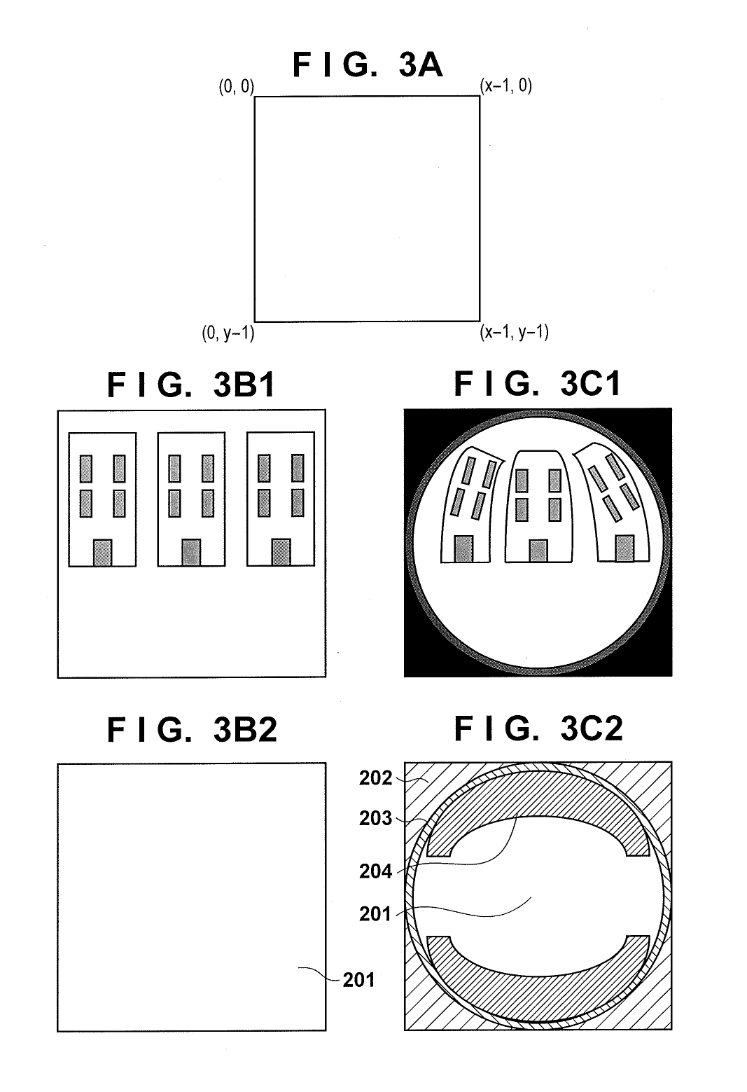

A lens characteristic notification process according to the first exemplary embodiment will be described. FIG. 2 shows an example of a table held by the lens characteristic determination unit 112 and indicating the relationship between the type of lens and the characteristics of each region. The encoding apparatus can hold the table by registering, in advance, information about lenses which may be used. The information in the table can be updated according to information provided by the lens 101, or updated by the encoding apparatus by downloading data from the outside. By assuming a case in which the horizontal component of the input image is divided into “x equal parts” and the vertical component of the input image is divided into “y equal parts”, FIG. 2 shows the characteristics of each divided pixel. The input image division method is as shown in FIG. 3A. The upper left corner of the image is set as an origin, and a pixel at the origin is represented by (0, 0). Each pixel has coordinate values in the horizontal and vertical directions corresponding to a position in the image. The x component of the coordinate values takes a value between 0 and x−1, and the y component of the coordinate values takes a value between 0 and y−1.

Examples of the lens are special lenses having a wide angle of field such as a 360° lens and fish-eye lens as well as a standard lens. Since such special lens has a wide angle of field, a region under the influence of the lens characteristics, more specifically, a region where distortion or information loss occurs or the light amount is insufficient may occur. In the table shown in FIG. 2, therefore, the characteristics of each region of the input image are set to one of an information loss region, light falloff region, and strong distortion region according to the type of lens. The lens characteristic determination unit 112 refers to the table based on information about the type of lens acquired from the lens 101, and notifies the block size determination unit 116 of characteristic information corresponding to the type of lens in use.

Note that a normal region 201 indicates a usable pixel region which has no problem such as distortion, information loss, or light falloff. An information loss region 202 indicates a pixel region where no light from the lens 101 enters the imaging plane of the sensor 102 and thus no significant information can be obtained. A light falloff region 203 indicates a pixel region where light from the lens 101 enters the imaging plane of the sensor 102 but the light amount is insufficient. A strong distortion region 204 indicates a pixel region where strong distortion has occurred due to the structure of the lens. Note that the information loss region 202, light falloff region 203, and strong distortion region 204 may be collectively referred to as “lens characteristic regions” hereinafter in the following exemplary embodiments.

If the type of the lens 101 is “lens 1”, the lens characteristic determination unit 112 notifies the block size determination unit 116 that all regions (0, 0) to (x−1, y−1) are “normal regions”. If the type of the lens 101 is “lens 2”, the lens characteristic determination unit 112 notifies the block size determination unit 116 that the regions (0, 0) and (1, 0) are “light falloff regions” where the light amount is small, and that the regions (2, 0) to (4, 0) are “strong distortion regions”, and then notifies the block size determination unit 116 of pieces of information of the regions (5, 0) to (x−1, y−1).

If the type of the lens 101 is “lens 3”, the lens characteristic determination unit 112 notifies the block size determination unit 116 that the regions (0, 0) to (2, 0) are “information loss regions” where no light reaches the sensor 102, and that the regions (3, 0) and (4, 0) are “strong distortion regions”, and then notifies the block size determination unit 116 of information of each of the regions (5, 0) to (x−1, y−1). If the type of the lens 101 is “lens 4”, the lens characteristic determination unit 112 notifies the block size determination unit 116 that the regions (0, 0) to (2, 0) are strong distortion regions, and that the regions (3, 0) and (4, 0) are normal regions, and then notifies the block size determination unit 116 of pieces of information of the regions (3, 0) to (x−1, y−1).

A practical example of the above process will be explained with reference to FIGS. 3B1 to 3C2. FIG. 3B1 to 3C2 are views showing images respectively captured by the standard lens and fish-eye lens, and the lens characteristics of each region. In FIG. 3B1, an image captured by the standard lens is shown. In FIG. 3B2, the lens characteristics of each region of the image captured by the standard lens are shown. In FIG. 3C1, an image obtained by capturing the same scene as that shown in FIG. 3B1 using the fish-eye lens is shown. In FIG. 3C2, the lens characteristics of each region of the image captured by the fish-eye lens and shown in FIG. 3C1 are shown. Reference numerals 201 to 204 denote the same components as those shown in FIG. 2.

When comparing of FIGS. 3B1 and 3C1 with each other, with respect to the image captured by the fish-eye lens and shown in FIG. 3C1, an image capture region is reduced from the entire screen to a circular region, and no light can reach outside the image capture region. Furthermore, light falloff at the edges of the image capture region occurs, and the image is distorted toward the upper or lower edge. Since the image shown in FIG. 3B1 has been captured by the standard lens, the lens characteristics shown in FIG. 3B2 indicate that all the regions of the image are normal regions 201. On the other hand, since the image shown in FIG. 3C1 has been captured by the fish-eye lens, the lens characteristics shown in FIG. 3C2 indicate that regions outside the image capture region reduced to the circular region are information loss regions 202, the edge regions of the image capture region are light falloff region 203 due to light falloff, and the upper and lower edge regions of the image capture region are strong distortion regions 204 due to the distorted image.

In the first exemplary embodiment, the fish-eye lens has been used. As for other lenses, each region of an input image is set as one of the normal region 201, information loss region 202, light falloff region 203, and strong distortion region 204 according to the type of lens, similarly to the fish-eye lens. The lens characteristic determination unit 112 notifies the block size determination unit 116 of information of each region by referring to the table according to the type of lens.

<Block Size Determination Process>

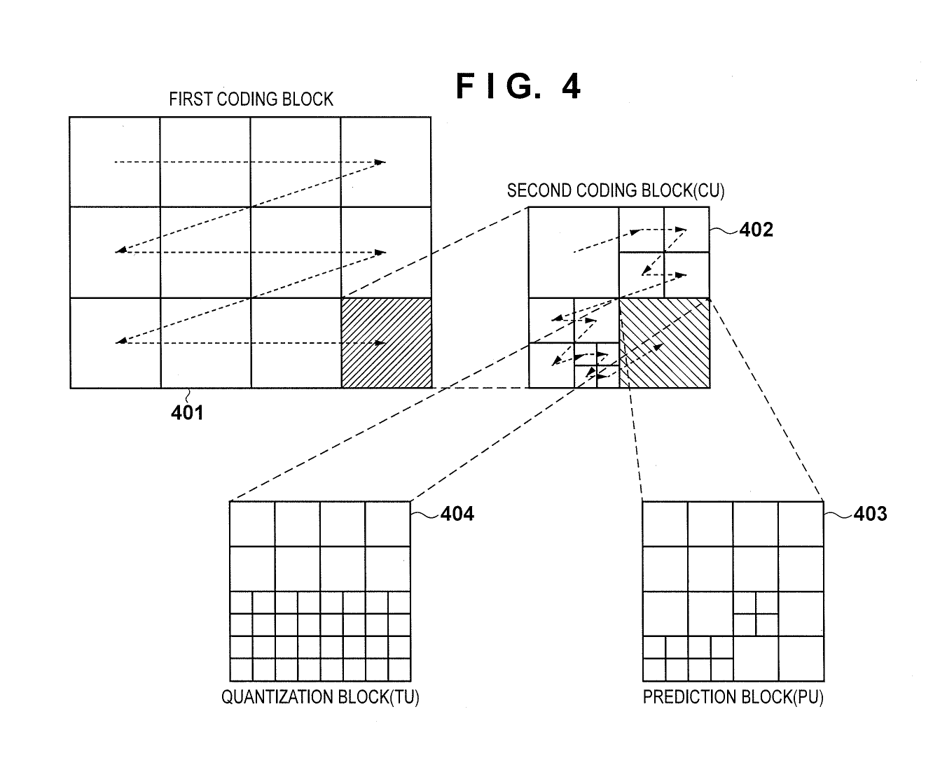

FIG. 4 is a view showing each block size determined by the block size determination unit 116. First coding blocks 401 are obtained by equally dividing the input image into, for example, 64 vertical pixels×64 horizontal pixels, and also called “LCUs (Largest Coding Units)”. The coding process using the first coding blocks 401 is executed in an order from the upper left block to the lower right block.

Second coding blocks 402 are obtained by dividing the first coding block 401 into smaller parts, correspond to actual coding target blocks, and are also called “CUs (Coding Units)”. Each second coding block 402 can have a size of 64, 32, 16, or 8 pixels in either of the vertical and horizontal directions. Similarly to the first coding blocks 401, the second coding blocks 402 are processed in an order from the upper left block to the lower right block. A motion compensation process, an intra-prediction process, an orthogonal transformation process, a quantization process, and an arithmetic coding process are executed within the second coding block.

Prediction blocks 403 are obtained by dividing the second coding block 402 into smaller parts, and are units used when each of the motion search unit 110, motion compensation unit 111, and intra-prediction unit 117 executes a process, and are called “PUs (Prediction Units)”. Each prediction block 403 can have a size of 64, 32, 16, 8, or 4 pixels in either of the vertical and horizontal directions. Note that for the prediction blocks 403, block patterns for motion search are sequentially selected based on the determined block size of the CUs. For example, the size of the CUs is 2N× 2N, a block pattern having a size of 2N×2N, 2N×N, N×2N, or N×N is selected for the motion compensation process. For the intra-prediction process, a block pattern having a size of 2N×2N or N×N (N=4) is selected.

Quantization blocks 404 are obtained by dividing the second coding block 402 into smaller parts, and are units used when each of the orthogonal transformation unit 104 and the quantization unit 105 executes a process, and are also called “TUs (Transform Units)”. Each quantization block 404 can have a size of 32, 16, 8, or 4 pixels in either of the vertical and horizontal directions.

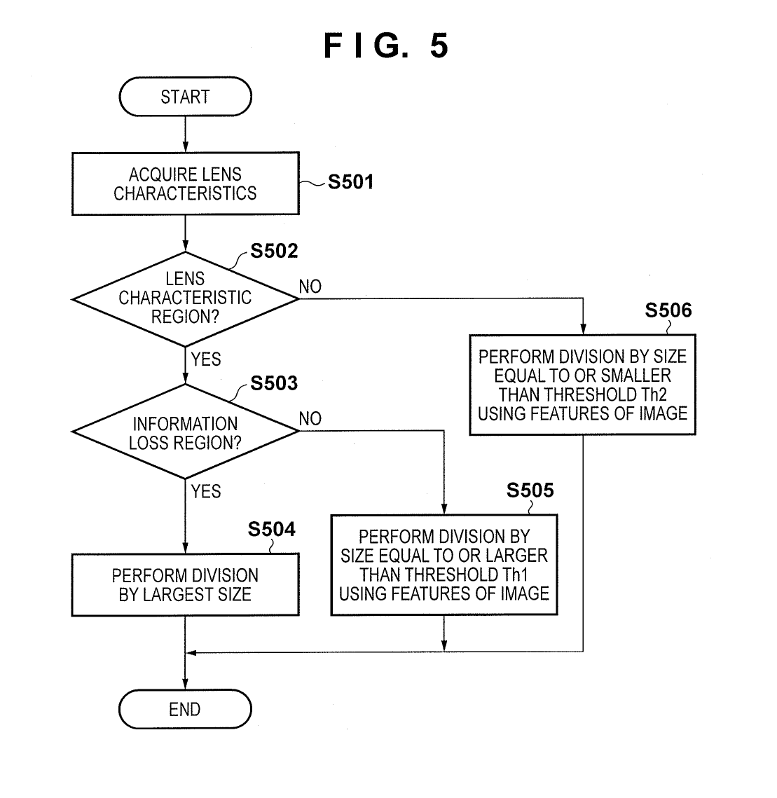

A block size determination process executed by the block size determination unit 116 will be described with reference to a flowchart shown in FIG. 5. FIG. 5 is a flowchart illustrating an example of block size determination process of determining a size of the second coding block and the quantization block, which is executed by the block size determination unit 116. The block size determination process is executed for each first coding block, and continued until the overall input image is processed. The block size determination process corresponding to the flowchart can be implemented when the CPU functioning as the block size determination unit 116 executes a corresponding program (stored in a ROM or the like).

In step S501, the block size determination unit 116 acquires lens characteristic information corresponding to the type of lens attached to the encoding apparatus from the lens characteristic determination unit 112. In step S502, the block size determination unit 116 determines whether a processing target block includes a region (lens characteristic region) belonging to a predetermined region where the lens characteristics influence the image quality. More specifically, the block size determination unit 116 determines whether a region where characteristics except for the normal region 201 appear as the lens characteristics is included. If only the normal region 201 is included (“NO” in step S502), the block size determination unit 116 advances to step S506. On the other hand, if one of the information loss region 202, light falloff region 203, and strong distortion region 204 of the lens characteristic regions is included (“YES” in step S502), the block size determination unit 116 advances to step S503. The block size determination process is independently performed for each of the lens characteristic region and another region (the normal region 201) in the input image.

In step S503, the block size determination unit 116 determines whether all the lens characteristics included in the processing target block indicate the value of the information loss region 202. If all the lens characteristics indicate the value of the information loss region 202 (“YES” in step S503), the block size determination unit 116 advances to step S504. Alternatively, if a value other than that of the information loss region 202 is also included (“NO” in step S503), the block size determination unit 116 advances to step S505.

In step S504, the block size of each of the second coding block and the quantization block is determined as a largest block size. Note that for the second coding block, the block size (64 pixels×64 pixels) of the first coding block is determined as a largest block size. For the quantization block, a possible largest size is a size of 32 pixels×32 pixels. In step S505, the features of the image of the processing target block are determined to discriminate between a complicated region (a region including many high-frequency components) where degradation is unnoticeable and a flat region (a region including many low-frequency components) where degradation is noticeable. In order to set different quantization widths for the complicated region and the flat region, the block size of each of the second coding block and the quantization block is determined so that the complicated region and the flat region do not coexist in the quantization block. In the case of the quantization block, for example, the largest size is 32 pixels×32 pixels. Therefore, the first coding block is divided into four parts. If the complicated region and the flat region coexist in the divided block, the block is further divided into four parts to separate the regions. On the other hand, if the regions do not coexist, the block need not be further divided. The aforementioned process is repeated within the range of an allowable block size so as to reduce coexistence of the complicated region and the flat region in the divided block as much as possible. Note that if the block size is too small, the coding amount increases. The allowable coexistence ratio may be set in advance. In this case, if the coexistence ratio in the divided blocks is lower than the allowable coexistence ratio, it is not necessary to further perform a division process. In this case, the block size determination unit 116 determines the block size of each of the second coding block and the quantization block to be equal to or larger than a predetermined threshold Th1. The threshold Th1 can be set to, for example, 16 pixels×16 pixels. Note that the reason why such threshold is set is because the processing target block in step S505 includes a pixel with distortion, information loss, or light falloff, and thus performing a fine quantization process by subdividing the blocks unnecessarily increases the coding amount.

In step S506, the block size determination unit 116 determines the block size of each of the second coding block and the quantization block. Similarly to step S505, the block size determination unit 116 repeats the process until the complicated region and the flat region do not coexist in the divided blocks of the block. At this time, the block size determination unit 116 determines the block size of each of the second coding block and the quantization block to be equal to or smaller than a predetermined threshold Th2. The threshold Th2 can be set to, for example, 16 pixels×16 pixels. Note that the threshold Th2 may be the same as or different from the threshold Th1. Note that the reason why such threshold is set is because the processing target block in step S506 includes a normal pixel without distortion or the like, and performing the fine quantization process by subdividing the block has merits, unlike step S505.

With the above-described processes, it is possible to reduce the coding amount by setting a large block size for the lens characteristic regions such as information loss region, light falloff region, and strong distortion region in the input image. At the same time, it is possible to finely adjust the coding amount by assigning a small block size to a region except for the lens characteristic regions. Note that since each block includes one motion vector and one quantization parameter, if a block size is made larger, it is possible to decrease the number of motion vectors and that of quantization parameters, as compared with a case in which a region is divided into smaller blocks, thereby reducing the coding amount. On the other hand, by setting a small block size, it is possible to set a motion vector and quantization width corresponding to each block. As described above, by selecting a block size according to the features of the input image, the coding efficiency improves, and a coded stream with higher image quality can be generated.

Although the method of determining the size of a quantization block has been mainly described in the first exemplary embodiment, the present invention is also applicable to a method of determining the size of another block such as a prediction block. For example, for a prediction block, a plurality of block patterns are selected based on the second coding blocks. At the time of selecting the block patterns, a pattern in which a complicated region and a flat region coexist can be excluded to select a pattern without coexistence.

### Second Exemplary Embodiment

In the above-described first exemplary embodiment, the block size determination unit 116 acquires lens characteristic information based on the type of the attached lens 101 from the lens characteristic determination unit 112, and determines a block size in consideration of the features of an input image by referring to the lens characteristic information. To the contrary, in the second exemplary embodiment, a block size determination unit 116 determines a block size based on features of an input image without referring to lens characteristic information. After that, a block size changing unit 119 acquires lens characteristic information from a lens characteristic determination unit 112, and changes the determined block size.

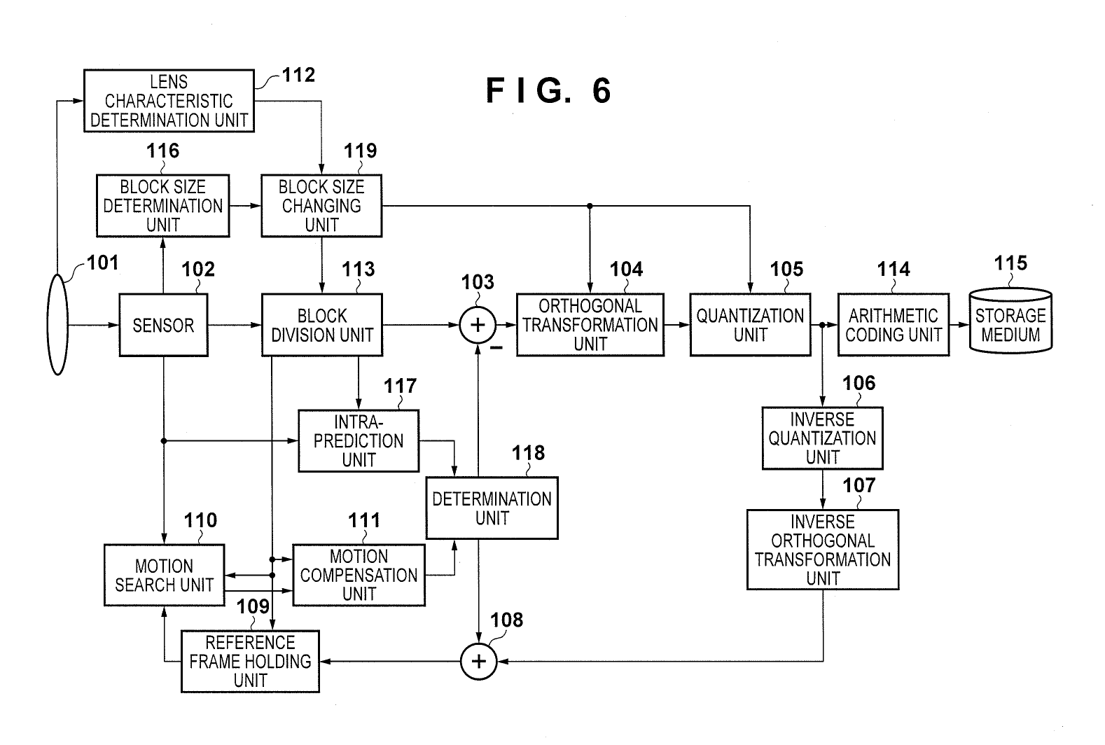

FIG. 6 is a block diagram showing an example of an arrangement of an encoding apparatus according to the second exemplary embodiment. The lens characteristic determination unit 112 recognizes the type of an attached lens 101, and notifies the block size changing unit 119 of a region, of a screen, where the characteristics of the attached lens appear. The lens characteristic detection method is the same as that described in the first exemplary embodiment.

The block size determination unit 116 divides an input image captured by a sensor 102 into a plurality of first coding blocks, a plurality of second coding blocks, a plurality of prediction blocks, and a plurality of quantization blocks, and notifies the block size changing unit 119 of it. Division into the second coding blocks, prediction blocks, and quantization blocks are performed according to the features of the image, similarly to the first exemplary embodiment. That is, the features of the image of a processing target block are determined to discriminate between a complicated region (a region including many high-frequency components) where degradation is unnoticeable and a flat region (a region including many low-frequency components) where degradation is noticeable. Each block is subdivided so that the complicated region and the flat region do not coexist as much as possible. This makes it possible to set a quantization width corresponding to each region. Note that although the upper and lower limits of a block size have been set in the first exemplary embodiment, the block size is not limited according to a threshold in the second exemplary embodiment.

The block size changing unit 119 changes the size of each of the second coding block, prediction block, and quantization block, which has been determined by the block size determination unit 116, using the information sent by the lens characteristic determination unit 112. A block size changing process of the block size changing unit 119 will be described in detail later. A block division unit 113 divides the input image into blocks based on the block sizes sent by the block size changing unit 119, and provides the blocks to a processing block of the succeeding stage.

<Block Size Changing Process>

The block size changing process executed by the block size changing unit 119 will be described. The block size changing unit 119 acquires the size information of each of the second coding block, prediction block, and quantization block from the block size determination unit 116. The block size changing unit 119 also acquires lens characteristic information based on the type of the lens 101 from the lens characteristic determination unit 112. The lens characteristic information is the same as that shown in FIG. 2. The block size changing unit 119 changes each block size based on the received lens characteristic information.

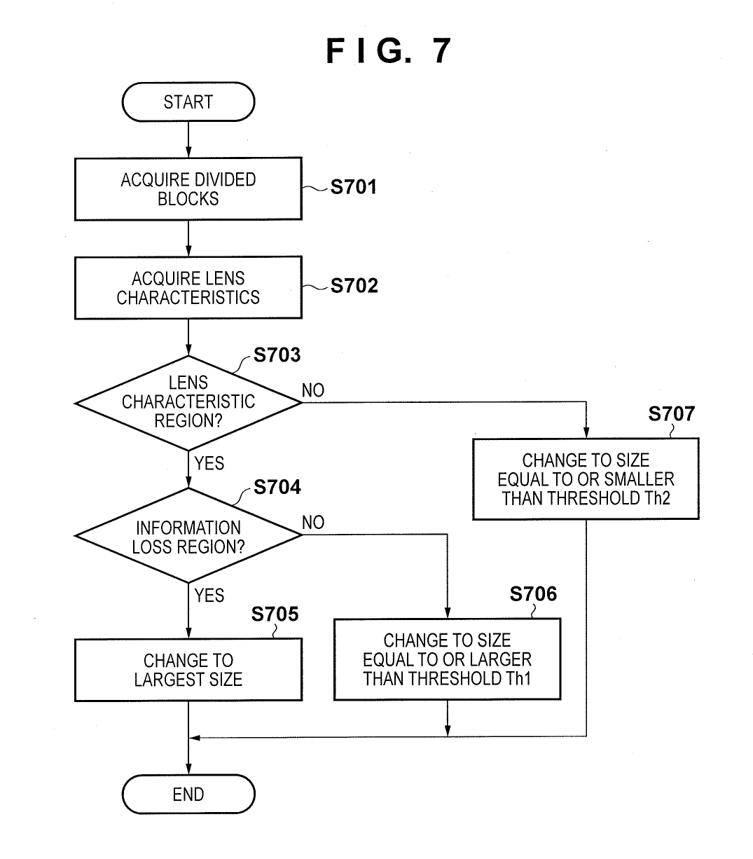

A practical changing method will be described with reference to a flowchart shown in FIG. 7. FIG. 7 is a flowchart illustrating an example of the block size changing process executed by the block size changing unit 119. The block size changing process is executed for each first coding block, and continued until the overall input image is processed. The block size changing process corresponding to the flowchart can be implemented when, for example, a CPU (Central Processing Unit) functioning as the block size changing unit 119 executes a corresponding program (stored in a ROM or the like).

In step S701, the block size changing unit 119 acquires the block size of each of the second coding block, prediction block, and quantization block obtained from the block size determination unit 116. In step S702, the block size changing unit 119 acquires lens characteristic information from the lens characteristic determination unit 112. In step S703, the block size changing unit 119 determines whether a block to undergo changing process belongs to a predetermined region (lens characteristic region) where the lens characteristics influence the image quality. If the block corresponds to a region where the lens characteristics appear (“YES” in step S703), the block size changing unit 119 advances to step S704. On the other hand, if the block corresponds to a normal region 201 (“NO” in step S703), the block size changing unit 119 advances to step S707. The block size changing process is independently performed for each of the lens characteristic region and another region (the normal region 201) in the input image.

In step S704, the block size changing unit 119 determines whether all the first coding blocks to be processed correspond to information loss regions 202. If all the first coding blocks correspond to the information loss regions 202 (“YES” in step S704), the block size changing unit 119 advances to step S705. On the other hand, if a region other than the information loss regions 202 is included, the block size changing unit 119 advances to step S706. In step S705, the block size changing unit 119 changes the block size of each of the second coding block and quantization block to the largest block size. For the second coding block, for example, the block size changing unit 119 changes the block size to that (64 pixels×64 pixels) of the first coding block. For the quantization block, the block size changing unit 119 changes the block size to 32 pixels×32 pixels. In step S706, the block size changing unit 119 changes the block size of each of the second coding block and quantization block to be equal to or larger than a block size corresponding to a predetermined threshold Th1. In step S707, the block size changing unit 119 changes the block size of each of the second coding block and quantization block to be equal to or smaller than a block size corresponding to a predetermined threshold Th2. In this example, each of the predetermined thresholds Th1 and Th2 can be set to, for example, 16 pixels×16 pixels. Note that the thresholds Th1 and Th2 may be the same or different.

Note that as described in the first exemplary embodiment, the size of a prediction block is determined based on the size of the second coding block, and thus it is only necessary to change the size of the second coding block. When selecting a plurality of block patterns for the prediction block based on the second coding blocks, a pattern in which a complicated region and flat region coexist can be excluded to select a pattern without coexistence.

As described above, even for a general block whose block size is determined by the block size determination unit 116 using the features of an image, the coding efficiency improves by adding the block size changing unit 119. Similarly to the first exemplary embodiment, therefore, it is possible to provide an encoding apparatus for generating a high-quality coded stream. In the second exemplary embodiment, the size of the quantization block is selected using the lens characteristics. However, the present invention is also applicable when another block size is used.

### Other Exemplary Embodiments

Exemplary embodiments of the present invention can also be realized by a computer that executes a program stored in a storage medium (e.g., non-transitory computer-readable storage medium) to perform the functions of one or more of the above-described embodiments of the present invention, and by a method performed by the computer of the system or apparatus by, for example, reading out and executing the program from the storage medium to perform the functions of one or more of the above-described embodiments. The computer may comprise one or more of a central processing unit (CPU), micro processing unit (MPU), or other circuitry, and may include a network of separate computers or separate computer processors. The program may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention is described with reference to exemplary embodiments, it is to be understood that the present invention is not limited to the exemplary embodiments. The scope of the following claims is to be accorded the broadest interpretation so as to encompass all modifications and equivalent structures.

This application claims the benefit of Japanese Patent Application No. 2013-181562 filed Sep. 2, 2013, which is hereby incorporated by reference herein in its entirety.

What is claimed is:

1. An encoding apparatus comprising:
an image capture unit configured to capture an image through a lens;
a characteristic determination unit configured to determine characteristics of the image based on a difference between a predetermined region where characteristics of the lens influence image quality and another region;
a size determination unit configured to determine, based on the characteristics of the image, a block size used to divide a target block included in the image;
a division unit configured to divide the target block into a plurality of blocks based on the determined block size; and
a prediction coding unit configured to encode the plurality of blocks.

2. The encoding apparatus according to claim 1, wherein the block size determined for the remaining region includes a block size smaller than a block size assigned to the predetermined region.

3. The encoding apparatus according to claim 1, wherein the block size determined for the predetermined region includes a block size larger than a block size assigned to the remaining region.

4. The encoding apparatus according to claim 1, wherein
the predetermined region includes a region where information loss has occurred, and
if the region where information loss has occurred occupies the image of the first block, the size determination unit determines the block size as the first size.

5. The encoding apparatus according to claim 1, wherein the size determination unit determines the block size so as to separate a complicated region including many high-frequency components from a flat region including many low-frequency components in the image of the first block.

6. The encoding apparatus according to claim wherein the prediction coding unit includes:
a predicted image generation unit configured to generate a predicted image of a coding target block in the first block; and
a processing unit configured to perform orthogonal transformation and quantization for a prediction error between the predicted image and an image of the coding target block of the image, and
wherein the size determination unit determines the size of the coding target block as the block size.

7. The encoding apparatus according to claim 6, wherein the size determination unit further determines, as a size not larger than the block size of the coding target block, a block size used as a processing unit by the processing unit.

8. A method comprising:
capturing an image through a lens;
determining characteristics of the image, the characteristics of the image are determined by discriminating between a predetermined region where characteristics of the lens influence image quality and a remaining region in the image;
determining, based on the characteristics of the image, a block size used to divide a target block included in the image;
dividing the target block into a plurality of blocks based on the determined block size; and
prediction coding the plurality of blocks.

9. A non-transitory storage medium that stores a program causing a computer to execute a method, the method comprising:
capturing an image through a lens;
determining characteristics of the image, the characteristics of the image are determined by discriminating between a predetermined region where characteristics of the lens influence image quality and a remaining region in the image;
determining, based on the characteristics of the image, a block size used to divide a target block included in the image;
dividing the target block into a plurality of blocks based on the determined block size; and
prediction coding the plurality of blocks.
